(19) United States
(12) Patent Application Publication
(10) Pub. No.: US 2007/0080238 A1
(43) Pub. Date: Apr. 12, 2007

(54) Free flowing water fountain system

(76) Inventor: William Robert Hunter JR., Gales Ferry, CT (US)

Correspondence Address: William R. Hunter Jr., 4 Browns Crossing, Gales Ferry, CT, 06335, US

(21) Appl. No.: 11/243,747

(22) Filed: Oct. 6, 2005

(51) Int. Cl. B05B 17/08

(52) U.S. Cl. 239/17

(57) ABSTRACT

My system is designed to provide a continuous flow of water in a vertical motion, without the use of pumps, or electric components. My system uses water volume, mass, weight, and pressure, to create a continuous, vertical flow of water. The pressure is formed, as the water in the hopper, or bowl, flows down through pipes, or hoses, that reduce in diameter, from the starting point. The weight, volume, mass, and gravity of the water being forced down into a reduced hose, or pipe, will create a continuous, vertical flow of water. My invention is not a water fountain, it is a system to provide a fountain with an electrical free, flow of water, in a water fountain. My invention is maintenance free, only have to add water due to evaporation, or chemicals to keep the water clear.

My system is designed to provide a continuous flow of water. No pumps, or electrical components are required.

My system is based on water volume, mass, weight, and pressure. The pressure is formed when the water in the hopper, or bowl, flows into a larger hosed, reduced down to a smaller hose.

The weight, volume, mass, and the gravity of the water being forced into a reduced hose, will create a continuous flow of water.

My invention is not a water fountain, it is a system to have a continuous flow of water in a fountain. It is free flowing water, that will flow on it's own. The only maintenance required, is to add water, due to evaporation, and, add chemicals, to keep the water clear.

1. My invention causes a continuous flow of water, using the volume, mass, pressure, weight, and the gravity of water, in a vertical motion.

2. My invention does not need any electrical components, or pumps, for my system to work.

3. My invention works, because gravity forces the weight, volume, and mass of the water down through a hose, or pipe, that reduces in diameter, to create water pressure.

4. My invention forces water from the hopper, or bowl, to flow in a vertical motion, emptying into the starting point.

5. My invention can start with any size hopper, or bowl, with pipes, or hoses, that are reducing in diameter, to create a continuous, vertical flow of water.

6. My invention is maintenance free, only needs chemicals, to keep the water clear, or to add water, from evaporation.

7. My invention works on any size scale, hopper, pipes, or hoses to be determined by the size of the fountain to be used.
